(19) United States
(12) Patent Application Publication
(10) Pub. No.: US 2018/0162348 A1
(43) Pub. Date: Jun. 14, 2018

(54) SYSTEM AND METHOD OF CONTROLLING MOTOR FOR VEHICLE

(71) Applicants: HYUNDAI MOTOR COMPANY, Seoul (KR); KIA MOTORS CORPORATION, Seoul (KR)

(72) Inventors: Jung Shik KIM, Seoul (KR); Sanghoon MOON, Yongin-si (KR); YoungJin SHIN, Changwon-si (KR); WoongChan CHAE, Gwangmyeong-si (KR); Hyoungjun CHO, Suwon-si (KR)

(73) Assignees: HYUNDAI MOTOR COMPANY, Seoul (KR); KIA MOTORS CORPORATION, Seoul (KR)

(21) Appl. No.: 15/612,028

(22) Filed: Jun. 2, 2017

(30) Foreign Application Priority Data
Dec. 13, 2016 (KR) 10-2016-0169862

(51) Int. Cl. B60W 20/10; H02P 21/14; H02P 21/20

(52) U.S. Cl. CPC B60W 20/10; H02P 21/141; H02P 21/20; B60W 2510/081; B60K 6/387; B60W 2510/083; B60W 2520/10; B60W 2540/10; B60W 2540/12; B60W 2510/244

(57) ABSTRACT

A system and a method of controlling a drive motor for a vehicle is disclosed. The method of controlling a drive motor for a vehicle may include: detecting, by a data detector, a state data; calculating, by a vehicle controller, a demand torque based on the state data; calculating, by the vehicle controller, a current command based on the demand torque and a rotor position; and operating, by the vehicle controller, the drive motor based on the current command.

### CROSS-REFERENCE TO RELATED APPLICATION

This application claims priority to and the benefit of Korean Patent Application No. 10-2016-0169862, filed Dec. 13, 2016, the entire contents of which are incorporated herein by reference.

### FIELD

The present disclosure relates to a system of controlling a drive motor for a vehicle, and more particularly to a system and a method of controlling a drive motor for a vehicle which control the drive motor.

### BACKGROUND

The statements in this section merely provide background information related to the present disclosure and may not constitute prior art.

As problems of pollution are getting more serious, use of non-polluting energy becomes more important. Particularly, air pollution in a big city are getting worse. One of major causes of air pollution is exhaust gas from vehicles.

In order to solve such problems caused by exhaust gas and enhance fuel efficiency, environmentally-friendly vehicles including hybrid electric vehicles, electric vehicles, etc. have been developed and used.

The environmentally-friendly vehicles include an engine and a motor as power sources, and run with power generated in combustion by the engine and power of the motor converted from electrical energy stored in a battery.

The environmentally-friendly vehicle is generally provided with a TMED (Transmission Mounted Electric Device) type transmission in which a drive motor and a transmission are connected with each other.

The TMED type transmission of the environmentally-friendly vehicle includes an engine clutch mounted between the engine and the drive motor and selectively transmitting torque of the engine to a drive shaft.

The environmentally-friendly vehicle provides various driving modes such as electric vehicle (EV) mode where torque of the drive motor is used for running, hybrid electric vehicle (HEV) mode where both of the engine torque and the motor torque are used for running, etc. according to whether the engine clutch is engaged or not.

Recently, an interior permanent magnet synchronous motor (IPMSM) is increasingly used as the drive motor. The IPMSM has advantages of outputting maximum torque higher than that of other motors.

According to a conventional method of controlling a drive motor, the drive motor is controlled by considering DC components of d-axis magnetic and q-axis magnetic flux. If current is not a form of sinusoidal function, iron loss and/or copper loss is generated due to current harmonics. Therefore, efficiency may be deteriorated, and noise vibration harshness (NVH) occurs due to increase in torque ripple.

The above information disclosed in this Background section is only for enhancement of understanding of the background of the present disclosure and therefore it may contain information that does not form the prior art that is already known to a person of ordinary skill in the art.

### SUMMARY

The present disclosure provides a system and a method of controlling a drive motor for a vehicle having advantages of controlling the drive motor by considering magnetic flux harmonics.

One form of the present disclosure provides a system and a method of controlling a drive motor for a vehicle having further advantages of controlling the drive motor by considering d-axis magnetic flux and q-axis magnetic flux that are changed according to a rotor position.

A system of controlling a drive motor for a vehicle in an exemplary form of the present disclosure may include the drive motor as a power source.

The system of controlling a drive motor for a vehicle may include: a data detector configured to detect a state data for controlling the drive motor; and a vehicle controller configured to calculate a demand torque based on the state data, calculate a current command based on the demand torque and a rotor position, and to operate the drive motor based on the current command.

The current command matched to each demand torque, each magnetic flux and each rotor position may be stored in a current control map.

The vehicle controller may calculate the current command based on the demand torque, a magnetic flux and the rotor position from a current control map.

The vehicle controller may calculate the magnetic flux using a rotor speed of the drive motor and a battery voltage.

The system of controlling a drive motor for a vehicle may further include a motor speed detector configured to detect the rotor speed of the drive motor.

The system of controlling a drive motor for a vehicle may further include a motor position detector configured to detect the rotor position.

The data detector may include at least one of: a speed detector configured to detect a vehicle speed; an accelerator position sensor (APS) configured to detect a position of an accelerator pedal; and a brake position sensor (BPS) configured to detect a position of a brake pedal.

A method of controlling a drive motor for a vehicle in another exemplary form of the present disclosure may include: detecting, by a data detector, a state data; calculating, by a vehicle controller, a demand torque based on the state data; calculating, by the vehicle controller, a current command based on the demand torque and a rotor position; and operating, by the vehicle controller, the drive motor based on the current command.

The current command may be calculated from a current control map in which the current command matched to each demand torque, each magnetic flux and each rotor position is stored.

The method of controlling a drive motor for a vehicle may further include calculating, before the calculating the current command, a magnetic flux using a rotor speed of the drive motor and a battery voltage.

A method of controlling a drive motor for a vehicle in another exemplary form of the present disclosure may include: detecting, by a data detector, a state data of the vehicle; calculating, by a vehicle controller, a demand torque of the drive motor based on the state data of the vehicle; calculating, by the vehicle controller, a current command based on the demand torque of the drive motor, a magnetic flux and a rotor position of the drive motor; and operating, by the vehicle controller, the drive motor based on the current command.

The magnetic flux may be calculated from a rotor speed of the drive motor and a battery voltage.

The exemplary form of the present disclosure may improve efficiency of the drive motor by controlling the drive motor considering magnetic flux harmonics.

In addition, since the drive motor is controlled by considering d-axis magnetic flux and q-axis magnetic flux that are changed according to the rotor position, current ripple may be enhanced and NVH may be reduced or prevented.

Further, the effects which may be obtained or predicted by the exemplary form of the present disclosure will be explicitly or implicitly disclosed in the detailed description of the forms of the present disclosure. That is, various effects which are predicted by the exemplary forms of the present disclosure will be disclosed in the detailed description to be described below.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating main constituent elements of environmentally-friendly vehicle to which a system of controlling a drive motor for a vehicle;

FIG. 2 is a block diagram of a system of controlling a drive motor for a vehicle;

FIG. 3 is a diagram illustrating a drive motor in a system of controlling a drive motor for a vehicle; and

FIG. 4 is a flowchart of a method of controlling a drive motor for a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, an operating principle of a system and a method of controlling a drive motor for a vehicle in an exemplary form of the present disclosure will be described with reference to the accompanying drawings.

Further, in describing below exemplary forms of the present disclosure, well-known functions or constructions will not be described in detail since they may unnecessarily obscure the understanding of the present disclosure. Further, the following terminologies are defined in consideration of the functions in the present disclosure and may be construed in different ways by the intention of users and operators, practice, or the like. Therefore, the definitions thereof should be construed based on the contents throughout the present disclosure.

Further, to effectively describe core technical features of the present disclosure, terms may be appropriately changed, integrated, or separated for those skilled in the art in a technical field to which the present disclosure belongs to explicitly understand the present disclosure, but the present disclosure is not limited thereto.

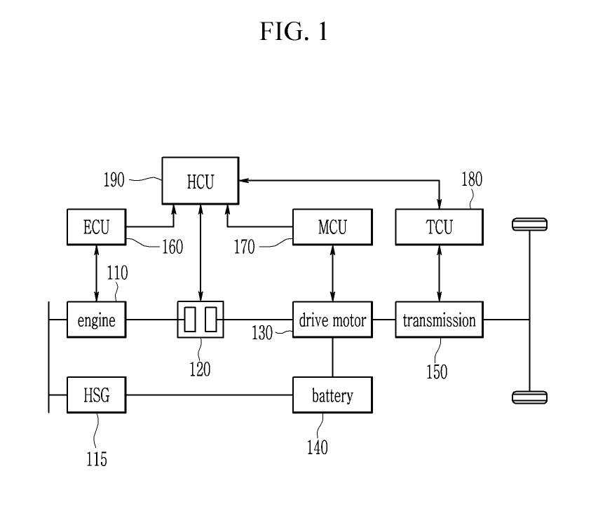

FIG. 1 is a diagram illustrating main constituent elements of environmentally-friendly vehicle to which a system of controlling a drive motor for a vehicle in one exemplary form of the present disclosure is applicable.

For better comprehension and ease of description, a hybrid electric vehicle is illustrated as one example of environmentally-friendly vehicles in FIG. 1. However, a system of controlling a drive motor for a vehicle in an exemplary form of the present disclosure can be applied to any environmentally-friendly vehicle using a motor as power source as well as a hybrid electric vehicle illustrated in FIG. 1.

Referring to FIG. 1, an environmentally-friendly vehicle, to which a system of controlling a drive motor is applicable, may include: an engine 110, a hybrid integrated starter-generator 115 (hereinafter ‘HSG’), an engine clutch 120, a drive motor 130, a battery 140, a transmission 150, an engine controller 160 (hereinafter ‘ECU’), a motor controller 170 (hereinafter ‘MCU’), a transmission controller 180 (hereinafter ‘TCU’) and a hybrid controller 190 (hereinafter ‘HCU’).

The engine 110 burns fuel to generate power. That is, the engine 110 may be any one of well-known various engines such as a gasoline engine and a diesel engine, etc. using a typical fossil fuel. Power of the engine 110 may be transmitted toward the transmission 150. The HSG 115 starts the engine 110, or operates as a generator to generate electrical energy when the engine 110 is operated.

The engine clutch 120 is disposed between the engine 110 and the drive motor 130 and is operated by control of the HCU 190 to operably connect or disconnect the engine 110 and the drive motor 130. That is, the engine clutch 120 operably connects or disconnects the engine 110 and the drive motor 130 according to switching between EV mode and HEV mode.

The drive motor 130 is operated by three-phase AC voltage supplied from the battery 140 through an inverter (not shown) to generate torque. The drive motor 130 is operated as a generator to supply regenerative energy to the battery 140 in coasting or regenerative braking conditions.

The battery 140 includes a plurality of unit cells, and high voltage for supplying driving voltage to the drive motor 130 is stored in the battery 140. The battery 140 supplies the driving voltage to the drive motor 130 at the EV mode or the HEV mode, and is charged by voltage generated by the drive motor 130 in the regenerative braking condition.

The transmission 150 receives output torque of the engine 110 when the engine clutch 120 is engaged, or output torque of the drive motor 130, and changes the output torque of the engine 110 and/or the output torque of drive motor 130 into target torque. That is, a suitable gear stage is selected according to a vehicle speed and a driving condition, and the received output torque is changed into the target torque. Then, the changed target torque is output to a driving wheel as the driving torque that runs the vehicle.

The ECU 160 is connected with the HCU 190 in wire or wireless manner, and controls, together with the HCU 190, overall operations of the engine 110 based on a demand torque signal of a driver and operating state of the engine such as a coolant temperature, an engine speed, a throttle valve opening, an intake amount, an oxygen amount, an engine torque, etc. The ECU 160 transmits the operating state of the engine 110 to the HCU 190.

The MCU 170 controls operation and torque of the drive motor 130 by control of the HCU 190, and causes voltage generated by the drive motor 130 in the regenerative braking to be stored in the battery 140. The MCU 170 controls overall operation of the drive motor based on a demand torque signal of the driver, running mode of the vehicle and state of charge (SOC) of the battery 140.

The TCU 180 controls a gear ratio according to output signals of the ECU 160 and the MCU 170 and determines regenerative braking amount. Here, the TCU 180 controls overall operation of the transmission 150. The TCU 180 transmits operating state of the transmission 150 to the HCU 190.

The HCU 190 is a top rank controller that determines running mode of the vehicle and controls overall operation of the vehicle. The HCU 190 controls low rank controllers connected through network. For example, the HCU 190 may be connected to the low rank controllers through controller area network (CAN). The HCU 190 gathers and analyzes information of the low rank controllers and controls the output torques of the engine 110 and/or the drive motor 130 cooperatively with the low rank controllers.

Since general operation of the environmentally-friendly vehicle supporting the above-mentioned functions is the same as or is similar to that of a conventional hybrid electric vehicle, detailed description thereof will be omitted.

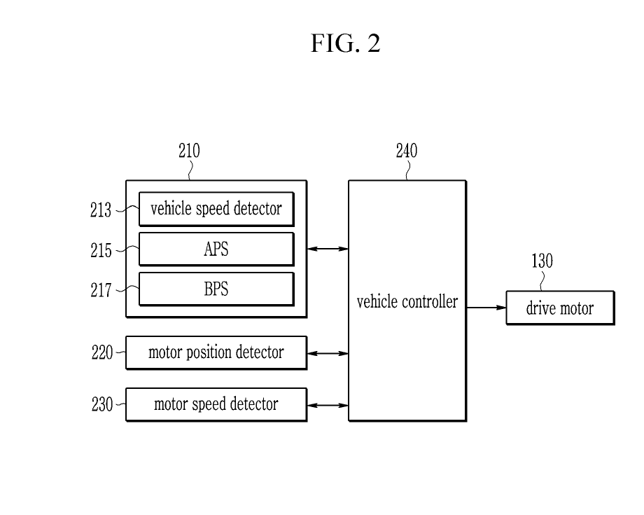

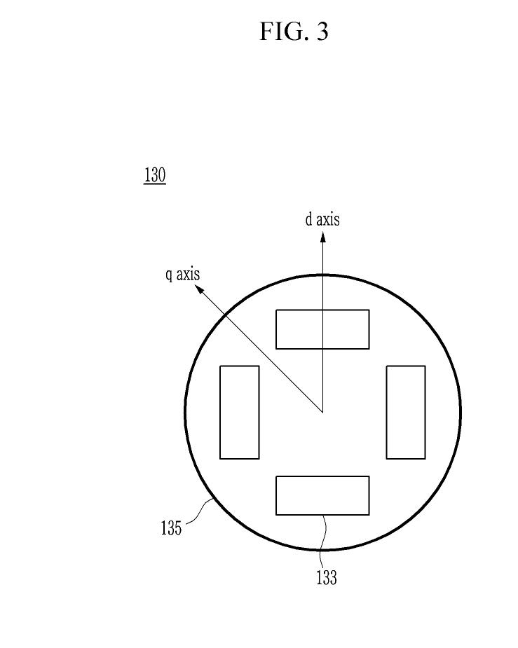

FIG. 2 is a block diagram of a system of controlling a drive motor for a vehicle in one exemplary form of the present disclosure, and FIG. 3 is a diagram illustrating a drive motor in a system of controlling a drive motor for a vehicle in one exemplary form of the present disclosure. Some steps of a method of controlling a drive motor in another form of the present disclosure may be performed by the MCU 170 and other steps thereof may be performed by the HCU 190. Further, since the MCU 170 and the HCU 190 may be embodied as one vehicle controller 240 according to the exemplary form of the present disclosure, for convenience description the MCU 170 and the HCU 190 will be called the vehicle controller 240, unless explicitly described otherwise in this specification and claims.

Referring to FIG. 2, the system of controlling a drive motor for a vehicle according to the exemplary form of the present disclosure includes the drive motor 130, a data detector 210, a motor position detector 220, a motor speed detector 230 and the vehicle controller 240.

The drive motor 130 is operated by three-phase AC voltage and controlled by the vehicle controller 240 to generate the torque. The drive motor 130, as shown in FIG. 3, may be embodied as an Interior Permanent Magnet Synchronous Motor (IPMSM) type in which a magnet 133 is inserted in a rotor core 135. However, the drive motor 130 is not limited to the IPMSM type.

The data detector 210 detects a state data for controlling the drive motor. For this purpose, the data detector 210 includes a vehicle speed detector 213, an accelerator position sensor (hereinafter ‘APS’) 215 and a brake position sensor (hereinafter ‘BPS’) 217.

The vehicle speed detector 213 detects a vehicle speed and transmits the detected vehicle speed to the vehicle controller 240.

The APS 215 detects how much a driver presses an accelerator pedal. That is, the APS 215 detects a position value of the accelerator pedal (how much the accelerator pedal is pressed) and transmits a signal corresponding to the detected position value to the vehicle controller 240. When the accelerator pedal is completely pressed, the position value of the accelerator pedal is 100%, and when the accelerator pedal is not pressed any more, the position value of the accelerator pedal is 0%.

Instead of using the APS 215, a throttle valve opening sensor mounted on an intake passage may be used.

The BPS 217 detects how much a driver presses a brake pedal. That is, the BPS 217 detects a position value of the brake pedal (how much the brake pedal is pressed) and transmits a signal corresponding to the detected position value to the vehicle controller 240. When the brake pedal is completely pressed, the position value of the brake pedal is 100%, and when the brake pedal is not pressed any more, the position value of the brake pedal is 0%.

The motor position detector 220 detects a position of a rotor included in the drive motor 130 and transmits the detected rotor position to the vehicle controller 240.

The motor speed detector 230 detects a rotation speed of the rotor included in the drive motor 130. The motor speed detector 230 transmits the detected rotor speed to the vehicle controller 240.

The vehicle controller 240 controls the drive motor 130, the data detector 210, the motor position detector 220 and the motor speed detector 230 that are constituent elements of the system of controlling a drive motor for a vehicle.

In other words, the vehicle controller 240 receives the state data from the data detector 210 and calculates a demand torque based on the state data. The vehicle controller 240 calculates a current command through a current control map by using the demand torque, a magnetic flux and the rotor position. The vehicle controller 240 operates the drive motor 130 based on the current command.

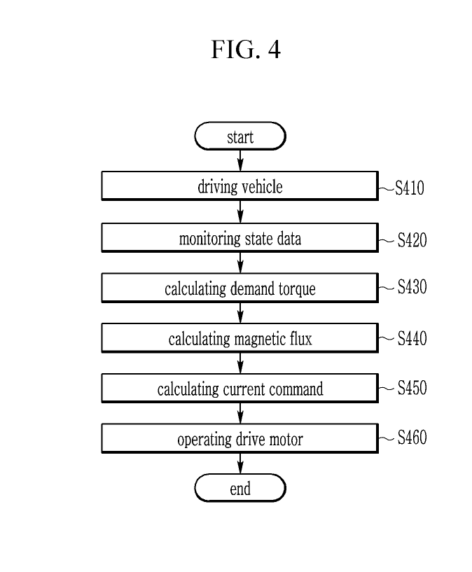

For this purpose, the vehicle controller 240 may be implemented by at least one processor operated by a predetermined program and the predetermined program may be programmed to perform a method of controlling a drive motor for a vehicle. The method of controlling a drive motor for a vehicle will be described in detail with reference to FIG. 4.

Referring to FIG. 4, a method of controlling the drive motor 130 of the environmentally-friendly vehicle will hereinafter be described.

FIG. 4 is a flowchart of a method of controlling a drive motor for a vehicle in one exemplary form of the present disclosure.

Referring to FIG. 4, when a starting button is ON by a driver, the vehicle controller 240 drives the vehicle by operating at least one of the engine 110 and the drive motor 130 at step S410.

While driving the vehicle, the vehicle controller 240 monitors the state data at step S420. In other words, the vehicle speed detector 213 of the data detector 210 detects the vehicle speed and transmits the vehicle speed to the vehicle controller 240. The APS 215 of the data detector 210 detects the position value of the accelerator pedal and transmits the position value to the vehicle controller 240. The BPS 217 of the data detector 210 detects the position value of the brake pedal and transmits the position value to the vehicle controller 240. The vehicle controller 240 monitors the vehicle speed, the position value of the accelerator pedal and the position value of the brake pedal transmitted from the data detector 210.

The vehicle controller 240 calculates the demand torque based on the state data at step S430. That is, the vehicle controller 240 calculates the demand torque of a driver based on the vehicle speed, the position value of the accelerator pedal and the position value of the brake pedal included in the state data.

The vehicle controller 240 calculates the magnetic flux at step S440. In other words, the vehicle controller 240 receives the rotor speed from the motor speed detector 230 and calculates the magnetic flux using the rotor speed and a battery voltage. At this time, the battery voltage may be calculated from the SOC of the battery 140. That is, the vehicle controller 240 calculates the magnetic flux through a following [Equation 1].

$$\frac{1}{λ} = \frac{\sqrt{3} {ω}_{r}}{{V}_{DC}} \qquad [ Equation 1 ]$$

Here, λ indicates the magnetic flux, ωᵣ indicates the rotor speed, and V_{DC} indicates the battery voltage.

The vehicle controller 240 calculates the current command based on the demand torque, the magnetic flux and the rotor position at step S450. In other words, the vehicle controller 240 receives the rotor position of the drive motor 130 from the motor position detector 220 and calculates the current command from the current control map. Here, the current control map may be embodied as 3-dimensional map, and the current command matched to each demand torque, each magnetic flux and each rotor position may be stored in the current control map in order to control the drive motor 130. The current control map may be set through a predetermined algorithm (e.g., program and/or probability model).

The vehicle controller 240 calculates the current command based on the demand torque, the magnetic flux and the rotor position through the current control map. At this time, the current command includes d-axis current command and q-axis current command for controlling the drive motor 130.

The vehicle controller 240 operates the drive motor 130 based on the current command at step S460. Here, the vehicle controller 240 controls 3-phase current applied to the drive motor 130 based on the d-axis current command and q-axis current command and operates the drive motor 130.

The system of controlling a drive motor for a vehicle in the exemplary form of the present disclosure calculates the current command through the current control map by considering the rotor position, and operates the drive motor 130 based on the current command. Therefore, current ripple may be enhanced and efficiency of the drive motor 130 may be increased.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

What is claimed is:

1. A system of controlling a drive motor for a vehicle which includes the drive motor as a power source, the system comprising:
a data detector configured to detect a state data for controlling the drive motor; and
a vehicle controller configured to calculate a demand torque based on the state data, calculate a current command based on the demand torque and a rotor position, and operate the drive motor based on the current command.

2. The system of claim 1, wherein the current command matched to each demand torque, each magnetic flux and each rotor position is stored in a current control map.

3. The system of claim 2, wherein the vehicle controller is configured to calculate the magnetic flux based on a rotor speed of the drive motor and a battery voltage.

4. The system of claim 3, further comprising a motor speed detector configured to detect the rotor speed of the drive motor.

5. The system of claim 1, wherein the vehicle controller is configured to calculate the current command based on the demand torque, a magnetic flux and the rotor position from a current control map.

6. The system of claim 1, further comprising a motor position detector configured to detect the rotor position.

7. The system of claim 1, wherein the data detector comprises at least one of:
a speed detector configured to detect a vehicle speed;
an accelerator position sensor (APS) configured to detect a position of an accelerator pedal; or
a brake position sensor (BPS) configured to detect a position of a brake pedal.

8. A method of controlling a drive motor for a vehicle, comprising:
detecting, by a data detector, a state data;
calculating, by a vehicle controller, a demand torque based on the state data;
calculating, by the vehicle controller, a current command based on the demand torque and a rotor position; and
operating, by the vehicle controller, the drive motor based on the current command.

9. The method of claim 8, wherein the current command is calculated from a current control map in which the current command matched to each demand torque, each magnetic flux and each rotor position is stored.

10. The method of claim 8, further comprising: calculating, before the calculating the current command, a magnetic flux based on a rotor speed of the drive motor and a battery voltage.

11. A method of controlling a drive motor for a vehicle, comprising:
detecting, by a data detector, a state data of the vehicle;
calculating, by a vehicle controller, a demand torque of the drive motor based on the state data of the vehicle;
calculating, by the vehicle controller, a current command based on the demand torque of the drive motor, a magnetic flux and a rotor position of the drive motor; and
operating, by the vehicle controller, the drive motor based on the current command.

12. The method of claim 11, wherein the magnetic flux is calculated from a rotor speed of the drive motor and a battery voltage.
